(19) United States
(12) Patent Application Publication
(10) Pub. No.: US 2007/0234331 A1
(43) Pub. Date: Oct. 4, 2007

(54) Targeted automatic patch retrieval

(75) Inventors: Peter H. Schow, Longmont, CO (US); Mark A. Son-Bell, Los Altos, CA (US); Gregory A. Williams, Colorado Springs, CO (US); Carl F. Meske JR., San Jose, CA (US); Arieh Markel, Lafayette, CO (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/326,735

(22) Filed: Jan. 6, 2006

(51) Int. Cl. G06F 9/44

(52) U.S. Cl. 717/168

(57) ABSTRACT

A method for maintaining patch information for a plurality of clients using a remote file system that includes obtaining component information from a report associated with each of the plurality of clients, populating a patch file on the remote file system when a component found on the plurality of clients is not current based on component information, and accessing the patch file on the remote file system to update the plurality of clients, wherein the report and the patch file are stored in the remote file system.

### BACKGROUND

Typical computer system software is updated throughout the lifetime of the software, particularly when new bugs in the application (i.e., an unintended and undesirable property or feature of software) are discovered and new features are added to the software. With each bug discovered and feature added, a patch may be released by the software vendor. A patch is a piece of software code which adds to and/or replaces a portion of the existing software code. A patch is typically installed without installing an entire application. By installing a patch, a user is able to maintain the reliability, integrity, and performance of the computer system software and application(s) and ensure that the computer system is current.

Typically, companies, educational institutions, and other large entities have thousands of computer systems to manage. Each computer system in the large entity may have dozens of applications, including various user productivity tools, compilers, system utilities, database applications, network and other operating system related utilities and software packages. Accordingly, managing a large entity when each of the computer systems constantly require reviews and updates in the form of patches is time-consuming and at times disruptive to the end user of the associated software applications.

In order to update each computer system, an administrator may have to sort through online knowledge bases and problem reports to find the applicable set of patches that apply to a particular computer system. Specifically, the administrator may attempt to access each application vendor's website on the Internet, enter the computer profile (i.e. software, hardware, etc.) and search for available patches. Once the administrator accesses the website, the administrator may or may not be able to find a list of patches from the vendor. In the event patches are found, then the administrator must review each patch to determine whether to install the patch. Deciding whether to install the patch requires the administrator to determine the difference between critical patches, recommended patches, and patches that are simply feature oriented. Specifically, the administrator must verify that the patch is safe to install and will not result in a system failure or crash. Once a patch has been verified to be installed, the administrator can download the associated patch to the affected computer system(s) and apply the patch to the computer system(s).

One method for making the process more efficient is for a large entity to use a dominant vendor. The dominant vendor has the knowledge base for most critical applications for several vendors at a single location (i.e., website). Thus, rather than accessing all of the application vendors, the administrator simply accesses the website of the dominant vendor.

### SUMMARY

In general, in one aspect, the invention relates to a method for maintaining patch information for a plurality of clients using a remote file system that includes obtaining component information from a report associated with each of the plurality of clients, populating a patch file on the remote file system when a component found on the plurality of clients is not current based on component information, and accessing the patch file on the remote file system to update the plurality of clients, wherein the report and the patch file are stored in the remote file system.

In general, in one aspect, the invention relates to a computer system for maintaining patch information for a plurality of clients using a remote file system that includes a remote file system for storing a report associated with each of the plurality of clients and a patch file, a processor within the computer system for executing software instructions to perform obtaining component information from the report, populating the patch file when a component found on the plurality of clients is not current based on component information, and accessing the patch file on the remote file system to update the plurality of clients.

In general, in one aspect, the invention relates to a system for maintaining patch information for a plurality of clients using a remote file system that includes a digital software library for storing a patch, and a business rules engine accessing the digital software library for obtaining component information from a report associated with each of the plurality of clients, populating a patch file on the remote file system when a component found on the plurality of clients is not current based on component information, and accessing the patch file on the remote file system to update the plurality of clients, wherein the report and the patch file are stored in the remote file system.

Other aspects and advantages of the invention will be apparent from the following description and the appended claims.

### BRIEF DESCRIPTION OF DRAWINGS

FIG. 1 shows a flow diagram of a system for patch retrieval in accordance with one or more embodiments of the invention.

FIG. 2 shows a flowchart of a method for patch retrieval at a backend data center in accordance with one or more embodiments of the invention.

FIG. 3 shows a flowchart of a method for patch retrieval at a client in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details.

In other instances, well-known features have not been described in detail to avoid unnecessarily complicating the description.

In general, embodiments of the invention provide a method and apparatus for efficiently retrieving patches for a client. Specifically, embodiments of the invention use a shared file system which is used for passing patch related information. More specifically, using the shared file system allows for the client to inform the backend data center of the state of the client and for the backend data center to add relevant patches to the client. Further, embodiments of the invention minimize administrator involvement in the patch retrieval process and improve the performance of the computer system by executing current updated versions of the software on the client.

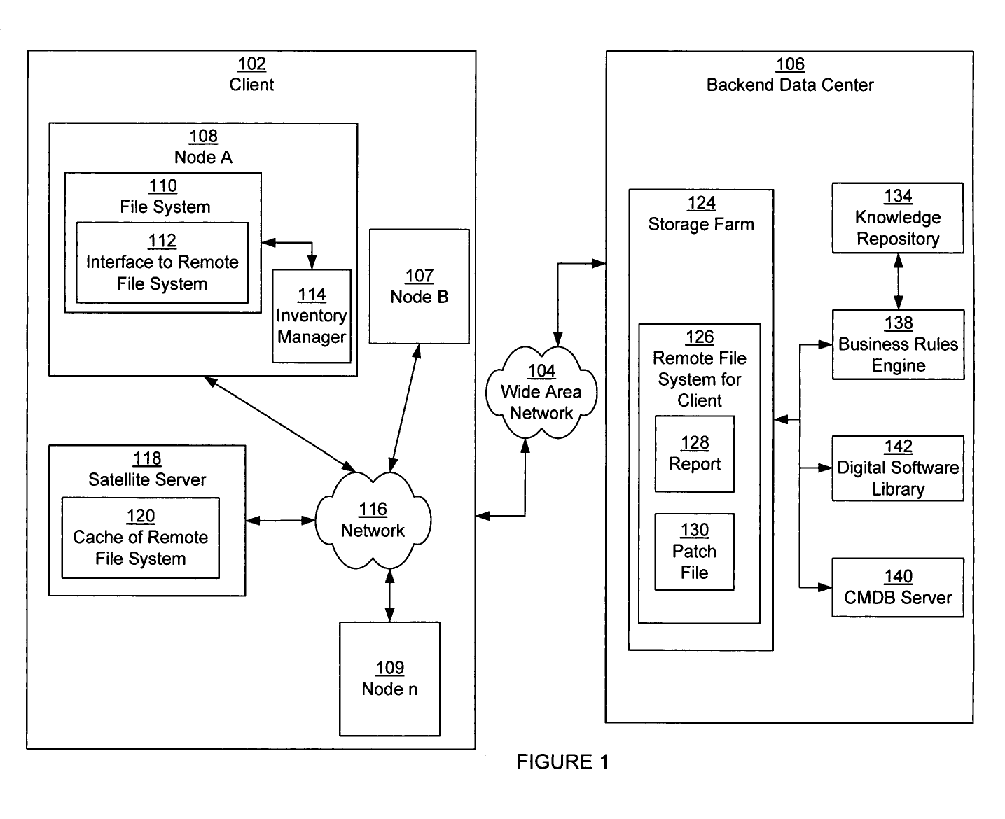

FIG. 1 shows a flow diagram of a system for patch retrieval in accordance with one or more embodiments of the invention. The system includes a client (102) connected to a backend data center (106) via a wide area network (104) (e.g., the Internet). Each of these components is described in detail below.
As shown in FIG. 1, the client (102) includes a node (e.g., node A (108), node B (107), node n (109)), a network (116), and satellite server (118). Each of these components is described in detail below.

A node (e.g., node A (108), node B (107), node n (109)) corresponds to any type of computing device, such as a laptop computer, personal digital assistant, server, desktop computer, etc. At least one node (e.g., node A (108)) on the client (102) includes a file system (110) and an inventory manager (114).

The file system (110) may correspond to a file system for the entire client (102) or only for the node (e.g., node A (108), node B (107), node n (109)). In one or more embodiments of the present invention, the file system (110) includes an interface to a remote file system (112). The interface to the remote file system (112) provides access to the remote file system for the client (126) (described below). Specifically, in one or more embodiments of the invention, as part of a directory structure for the file system (110) appears the remote file system. For example, a node may have a file system (110) with a “c:” drive which corresponds to a local hard drive, an “a:” drive which corresponds to a local floppy drive, and an “e:” drive which corresponds to the interface to remote file system (112). Accordingly, in one or more embodiments of the invention, an administrator or application may access files on the remote file system for the client (126) using a similar interface (i.e., user interface (UI) or application programming interface (API)) provided for accessing files on a local disk. Thus, in accordance with one or more embodiments of the invention, the remote file system for the client (126) is simultaneously visible to both the client (102) and the backend data center (106).

Continuing with FIG. 1, connected to the file system (110) is an inventory manager (114). The inventory manager (114) in one or more embodiments of the invention includes functionality to perform an inventory of the node (e.g., node A (108), node B (107), node n (109)) and/or the client (102). Specifically, in one or more embodiments of the invention, the inventory manager (114) is able to take an inventory of the amount of memory, number of disk drives, software packages, third party peripherals, and all other characteristics about the node (e.g., node A (108), node B (107), node n (109)) and/or client (102). The inventory manager (114) may also include functionality to store the inventory in a report (128) (described below) on the remote file system for the client (126) (described below).

Those skilled in the art will appreciate that node (e.g., node A (108), node B (107), node n (109)) may not be located within the parameters of client (102). Specifically, the node (e.g., node A (108), node B (107), node n (109)) may correspond to a laptop computer of a user in transit. Accordingly, in one or more embodiments of the invention, the node (e.g., node A (108), node B (107), node n (109)) may be directly connected to the wide area network (104).

However, when node (e.g., node A (108), node B (107), node n (109)) is within parameters of the client (102), and a network (116) may be used to connect the nodes (e.g., node A (108), node B (107), node n (109)). The network (116) may correspond to any type of mechanism for connecting nodes (e.g., node A (108), node B (107), node n (109)). Specifically, the network (116) may correspond to direct connections between the nodes (e.g., node A (108), node B (107), node n (109)), one or more local area network (LANs), wide area networks (WANs), and other such connections.

Connected to the nodes (e.g., node A (108), node B (107), node n (109))) via a network (116) is a satellite server (118). The satellite server (118) corresponds to one or more servers that include functionality to maintain a cache of the remote file system (120) for the client (102). The cache of the remote file system (120) maintains data accessed recently from the remote file system for the client (126). Accordingly, the satellite server (118) may include a synchronization protocol for synchronizing files between the cache for the remote file system (120) and the remote file system for the client (126). Having a cache for the remote file system (120) reduces bandwidth requirements and increases the availability for the remote file system for the client (126) on the client (102). Alternatively, those skilled in the art will appreciate that the cache for the remote file system (120) may not exist or may be stored directly in the node (e.g., node A (108), node B (107), node n (109)).

Continuing with FIG. 1, connected to the client system (102) using the Wide area network (104) is the backend data center (106). In one or more embodiments of the invention, the backend data center (106) corresponds to a group of connected servers (not shown) that include functionality to determine whether a node (e.g., node A (108), node B (107), node n (109)) is current and could obtain any update(s) that might be required. Components of the backend data center (106) may be physically located together (e.g., in the same building) or physically dispersed. The backend data center (106) includes a storage farm (124), a knowledge repository (134), a business rules engine (138), a configuration manager database server (CMDB server) (140), and a digital software library (142). Each of these components is described below.

The storage farm (124), in one or more embodiments of the invention, corresponds to at least one server that manages remote files for several clients (e.g., client (102)). A remote file (e.g., report (128), patch file (130)) corresponds to a file which is not stored on the client (102). Specifically, in one or more embodiments of the invention, each client has a remote file system for the client (126) at the storage farm (124).

The remote file system (126) stores a report (128) and a patch file (130). A report typically corresponds to an inventory of components for the client (102).

The components correspond to hardware (e.g., amount and type of memory, number of disks, as well as other types of hardware) and software (e.g., software packages, single applications, drivers, patches, and other such software) of the client (102). Those skilled in the art will appreciate that the report (128) may correspond to an inventory of all of the components or only a part of the components of the client (102). For example, the report (128) may only include components related to networking, components only of a particular node (e.g., node A (108), node B (107), node n (109)), or any other category of components.

Further, a report (128) may be used for each node (e.g., node A (108), node B (107), node n (109)) of the client (102), or for the entire client (102). In one or more embodiments of the invention, the report (128) also includes preference information, such as the types of patches in which an administrator is interested (e.g., based on the component types, critical level, as well as any other relevant criteria).

In one or more embodiments of the invention, the remote file system (126) also includes at least one patch file (130). The patch file (130) maintains at least one patch which is available to be installed on the client (102). Those skilled in the art will appreciate that a patch file may correspond to a folder containing multiple patches, a single executable patch, a patch with associated metadata, a file with data links to at least one patch, etc. A patch typically corresponds to a piece of software code which adds to and/or replaces a portion of the existing software code. A patch may usually be installed without installing an entire application.

Further, the patch file (130) may correspond to either a critical or non-critical patch. A critical patch is a patch which addresses vulnerabilities at the client. Specifically, a critical patch may be used to block security vulnerabilities and prevent attacks, such as viruses, Trojan horses, worms, and other attacks or to prevent the node from malfunctioning. A non-critical patch may add features or solve bugs, such as a single non-critical application failing, in the client (102). Further, the patch file (130) may also include information about the patch, such as a critical level, reason for the patch, and other such information.

Continuing with FIG. 1, in one or more embodiments of the invention, connected to the storage farm (124) is a configuration management database (CMDB) server (140). The CMDB server (140) maintains a CMDB, which includes functionality to store the information in the report (128) in a database format. Specifically, the CMDB may store the inventory of components, such as hardware and software, for the client (102) in a database format. By storing the inventory of the components into the CMDB, queries on the CMDB to find information about specific components may be optimized for performance. While FIG. 1 shows that the CMDB as a separate server, those skilled in the art will appreciate that the CMDB may be stored as a part of the remote file system of the client. Specifically, in one or more embodiments of the invention, the client may also query the CMDB for information.

Connected to the CMDB server (140) and the storage farm (124) is a Business Rules Engine (138). The business rules engine (138) includes functionality to access the inventory and determine the deficient (i.e., non-current) components of the inventory. Specifically, the output of the business rules engine (138) may include whether any components are deficient and information regarding which updates are recommended.

In one or more embodiments of the invention, connected to the business rules engine (138) is a knowledge repository (134). The knowledge repository (134) maintains a listing of rules of software components. The listing of the rules associates the different components of the client (102) with the available patches. Further, the knowledge repository (134) may also contain information about the patches, such as the cause of the patch, how critical the patch is, and other such information. For example, when a software vendor publishes an update, information regarding the update is added to the knowledge repository (134) in the form of a rule. Accordingly, in one or more embodiments of the invention, the knowledge repository (134) may be continuously kept updated by the vendors of the different components (not shown). Alternatively, the knowledge repository (134) may be updated by a web engine accessing the component vendors' websites. Typically, the knowledge repository (134) is continuously updated. Thus, the client (102) is assured to be maintained with at least the same updates that would be available if the administrator contacted the vendors directly.

Continuing with the backend data center (106), connected to the storage farm 24) and the business rules engine (138) is a digital software library (142). The digital software library (142) corresponds to a storage unit for maintaining the patches for the client (102). Accordingly, while information about a patch may be kept in the knowledge repository (134), the actual patch may be stored in the digital software library (142).

Typically, in order to access the remote file system (126) from a node (e.g., node A (108), node B (107), node n (109)), the remote file system for the client (126) is typically first mounted on the node (e.g., node A (108), node B (107), node n (109)). Mounting the remote file system for the client (126) may be performed in a central location of the client (102). Specifically, a user or administrator typically does not need to specify each node (e.g., node A (108), node B (107), node n (109)) on which to mount the remote file system for the client (126). Once the remote file system for the client (126) is mounted, then at startup, a file system manager is able to discover the remote file system for the client (126) and add the remote file system interface (112) to the file system. After adding the interface to the remote file system (112), the client is ready for patch retrieval.

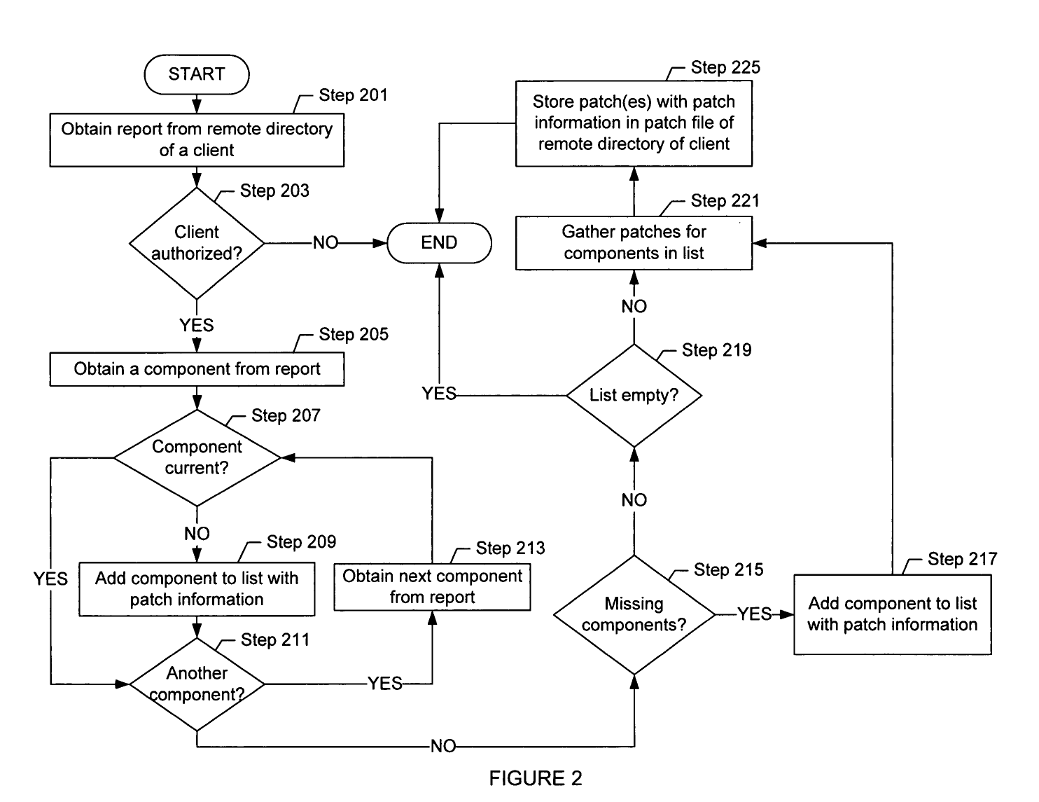

FIG. 2 shows a flowchart of a method for patch retrieval at a backend data center in accordance with one or more embodiments of the invention. Before performing the patch retrieval by the backend, an inventory manager on the client performs an inventory of the components of the client system (not shown). As stated above, the inventory of components may include the amount of memory, number of disk drives, drivers, single applications, software packages, third party peripherals, and any other relevant characteristics about the client. When the inventory manager stores the inventory in a report, the act of performing the storing appears to the inventory manager in the same manner as if only local storage was performed. Accordingly, in one or more embodiments of the invention, little extra configuration is required to a pre-existing inventory manager to store the report.

Accordingly, after the report is stored on the remote file system by the inventory manager, the report is obtained from the remote file system of the client (Step 201) by the backend. Next, a determination is made whether the client is valid (Step 203). Specifically, a determination is made whether the client has access to the services provided by the backend data center. Determining whether the client has access may be performed, for example, by checking metadata stored with the remote file system of the client for the access parameters of the client or determining whether a header of the report contains a certain authentication sequence. Alternatively, rather than determining whether the entire client has access and performing the authentication on a per client basis, authentication may be performed based on the node storing the report, the inventory manager, a user, etc.

Further, one skilled in the art will appreciate that because communication between the client and the backend data center is typically performed using the wide area network, various other security measures may be performed that are not shown in FIG. 2. For example, firewalls on both the client and the backend data center may be used to prevent intruders, data may be encrypted and decrypted, and any of the other myriad of security measures known in the art may be used.

Continuing with FIG. 2, if the client is valid, in one or more embodiments of the invention, the CMDB is next populated using the information stored in the report (not shown). Alternatively, the method may proceed using information directly from the report obtained in Step 201. Next, a component from the report is obtained (Step 205). The component may be obtained by reviewing components in the report obtained in Step 201, or obtained from the CMDB.

After obtaining the first component, a determination is made whether the component is current (Step 207). Determining whether the component is current may be performed by accessing the knowledge repository and reviewing updates made to the component by using information about the component stored in the report. Alternatively, the component may have a unique update identifier which specifies when the component was last updated. The knowledge repository may then be accessed with the unique update identifier to determine whether an update has been added since the last time the component was updated.

In one or more embodiments of the invention, determining which components are not valid may involve querying the CMDB database for the last time the components were updated and comparing the time the components were updated with a timestamp of the last update available for the component. The timestamp for the last update to the component may be stored in the knowledge repository. Those skilled in the art will appreciate that using the CMDB database allows for known algorithms that optimize comparison queries to be used.

Accordingly, determining which components require updates may be performed in batch.

Further, those skilled in the art will appreciate that multiple ways exist for determining whether a component is current using the component information. Additionally, maintaining the information in the knowledge repository may be performed in any number of mechanisms such as by using an update engine which checks component vendors' websites for updates, the component or software vendors sending updates, directly or indirectly, to the knowledge repository, by accessing a database of vulnerabilities, etc.

Continuing with FIG. 2, if the component is not current, then the component is added to a listing of non-current components with patch information (Step 209). The listing of non-current components may correspond to a file, stack, queue, or any other data structure or storage mechanism. The patch information, such as severity levels, vulnerability that is addressed by patch, vendor information, date of patch, may be obtained from the knowledge repository. Alternatively, the patch information may be obtained directly from the component vendor's website.

Regardless of whether a component is current or not, a determination is made whether another component is found in the report (Step 211). If another component is found, then the next component is obtained (Step 213) and the method continues with Step 207 (described above).

After ensuring that all components are updated, a determination is made whether there are any missing components (Step 215), such as missing anti-virus software. Missing components may be determined, for example, by querying the database against recommendations for components in the knowledge repository. If missing components are found, then the missing components are added to the list with patch information.

Those skilled in the art will appreciate that while not shown, generating the list of components that are missing or not current may be performed by the client. Specifically, the client may use existing knowledge sources or a listing of rules for a particular software product to determine whether certain software is outdated. Once the client has determined that software is outdated, the client may send a list of only the outdated software to the backend server which will result in the backend server retrieving the outdated patches.

Continuing with FIG. 2, if no missing components are found, then a determination is then made whether the list is empty (Step 219). Determining whether the list is empty may be performed by accessing the list and obtaining the number of bytes in the list, or accessing a counter associated with the list, or performing any method known in the art. Further, in one embodiment of the invention, a list may not be created unless components are added to the list. Accordingly, determining whether the list is empty may simply involve detecting whether the list exists.

If the list is not empty, then the patches for the components in the list are gathered (Step 221). The patches may be gathered from the digital software library. Those skilled in the art will appreciate that digital software library may be populated with the patches by an update engine which accesses the component vendors' website, by the component vendors' sending directly or indirectly the patches to the backend, or using any other possible mechanism for retrieving and storing patches.

Once the patches are gathered, then the patches are stored in one or more patch files in the remote file system of the client (Step 225). In one or more embodiments of the invention, a determination may be made whether the client specifies the type of patch to store in the patch file. For example, the client may specify that only the components with a certain severity level (i.e., minimum, critical, etc.) should be stored in the patch file. Accordingly, if the client does specify the type of patch to store in the patch file, then in one or more embodiments of the invention, only patches of the specified type are stored in the patch file. Those skilled in the art will appreciate that rather than storing the patches in a patch file, a link to the patches may instead be stored in the patch file. Specifically, the patches will be maintained on the component vendor's website.

Additionally, the patch information may also be stored in the patch file.

For example, the patch information that is added to the patch file may include information specifying the severity of the patch, affected components, the creation date of the patch or any other such information about the patch. Accordingly, once the patches are placed in the remote file system, then the patches are available for installation by a client.

In one or more embodiments of the invention, once the patch file is updated with the patches or links to the patches, the remote file system for the client and the satellite server are synchronized (not shown). Specifically, the patch file may be immediately transferred to the satellite server on the client. Accordingly, after the patch file is transferred, then any node on the client has access to the patches.

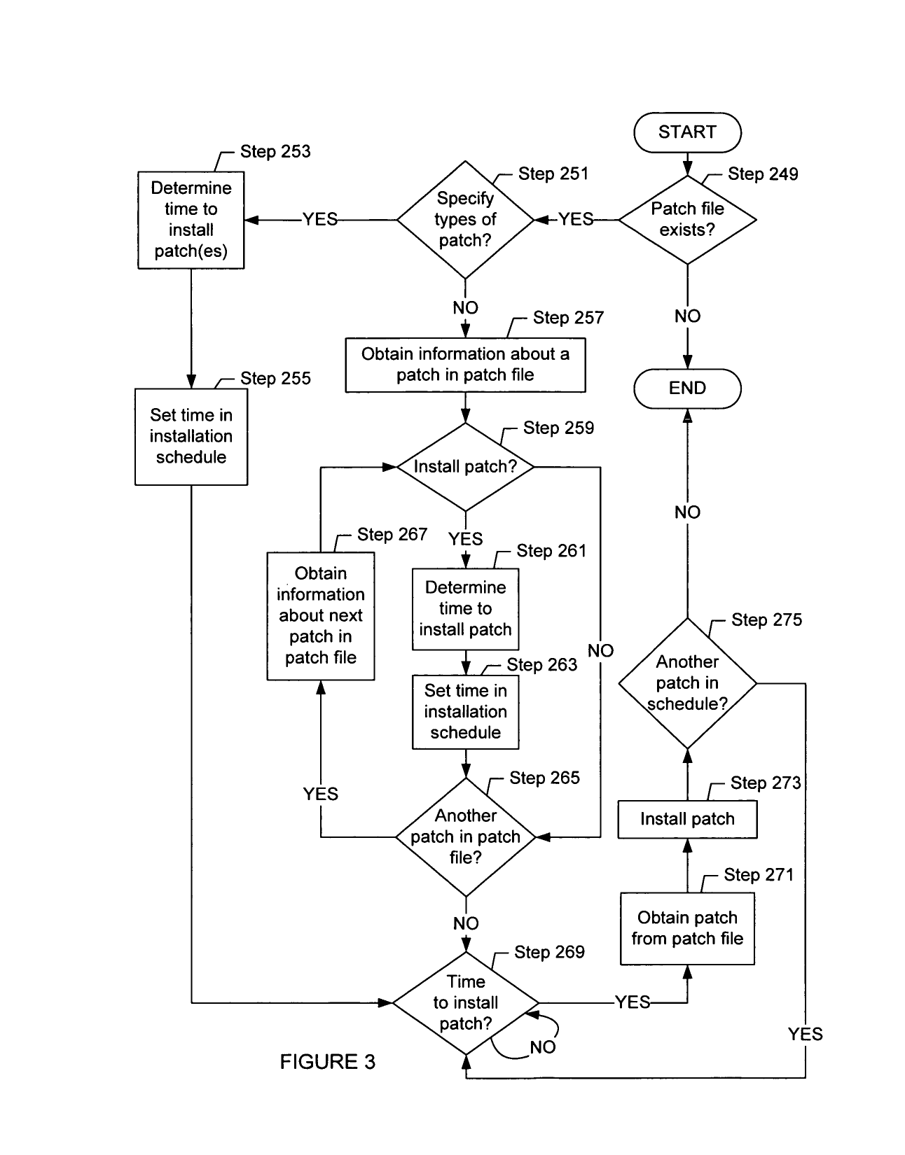

FIG. 3 shows a flowchart of a method for installing patches by a client using patch retrieval of the backend data center in accordance with one or more embodiments of the invention. Initially the client determines whether a patch file exists (Step 249). If a patch file does not exist, then the client may assume that the client is current or that no patches are available through the backend. Alternatively, if the patch file exists, then a determination is made whether the client has specified types of patches to store in the patch file (Step 251). If the client has specified a severity of patches to store in the patch file, then in one or more embodiments of the invention, the only patches in the file match the type. Accordingly, the client may desire for all patches in the patch file to be installed. Next, the time to install the patches in the patch file is determined (Step 253). For example, the client may require immediate installation or prefer to install the patches when the nodes on the client are not in heavy operation, such as the middle of the night. Thus, the client sets the time to install the patches in an installation schedule (Step 255).

Alternatively, if the client has not specified a type of the patch to store in the patch file, then information about a patch in the patch file is obtained from the patch file (Step 257). Next, using the information about the patch, a determination is made whether the patch should be installed (Step 259). Determining whether a patch file should be installed may be performed automatically, such as installing patches which meet a certain criteria (e.g., affected component is of a certain type, the patch is critical), or may be performed by an administrator reviewing the consolidated information. If the patch should be installed, then the time to install the patches in the patch file is determined (Step 261). Next, the time to install the patch is set in the installation schedule (Step 263).

After setting the time in the installation schedule if the patch is to be installed or if the patch is not to be installed, a determination is made as to whether another patch exists in the patch file (Step 265). If another patch exists in the patch file, then information about the next patch in the list is obtained (Step 267). After obtaining the next patch, the method continues with Step 259 (described above).

Once the patch file is empty, then if there are patches to install, a determination is made whether it is time to install a patch from the patch file (Step 269). Determining whether it is time to install the patches may be performed, for example, by accessing the installation schedule. Alternatively, the installation schedule may simple trigger the installation process when it is time to install the patches.

Once it is time to install the patch, the patch is obtained from the patch file (Step 271). Alternatively, a link to the patch may be obtained from the patch file.

Next, the patch is installed (Step 273). Installing the patch may be performed using virtually any of the mechanisms known in the art.

After installing the patch, a determination is made whether another patch is found in the installation schedule (Step 275). If another patch is found in the installation schedule, then the method continues with Step 269. Otherwise, when no more patches are found in the patch file, then the patches are installed in the client and the client is considered updated.

Those skilled in the art will appreciate that a listener may be configured on the client to perform any of the aforementioned steps of FIG. 3. Specifically, the listener may be configured to detect when new patches have arrived and install the patches at the time of arrival or set a time in the installation schedule to install the patch.

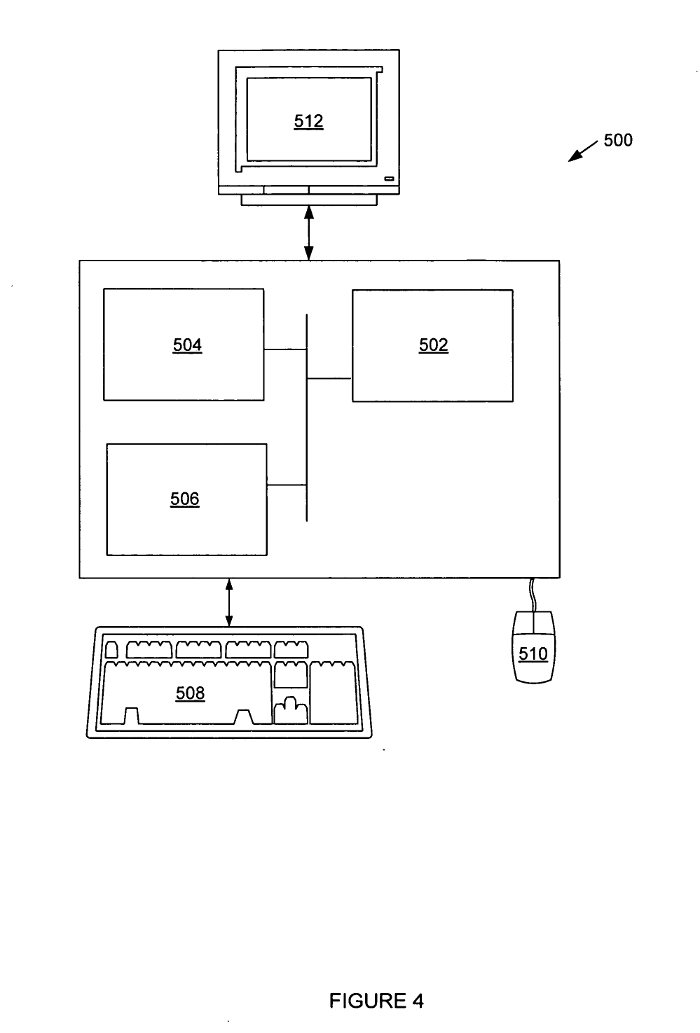

The invention may be implemented on virtually any type of computer regardless of the platform being used. For example, as shown in FIG. 4, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., computer system, file system of client, report, patch file, etc.) may be located on a different node within the distributed system. In one or more embodiments of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), DVD, a diskette, a tape, a file, or any other computer readable storage device.

Embodiments of the invention have one or more of the following advantages. First, embodiments of the invention provide a mechanism for maintaining a client with little administrator involvement. Specifically, by using the backend data center to determine how to keep a client current, the administrator does not need to visit each vendor individually. Additionally, rather than the administrator continuously visiting a website of a dominant vendor in order to ensure that the client is current, the inventory manager may simply inform the backend data center of changes to the client using the report. Using the continuously updated report and the continuously updated knowledge repository allows the backend data center to provide the client with the most current patches. Accordingly, more accurate patch sets may be retrieved for a given client.

Further, by providing the patches and information about the patches to the client using an interface allowing the patches to appear local, an environment is created that allows ease in maintaining the system. Specifically, any preexisting inventory manager only requires a slight modification to output a report containing the inventory to the remote file system rather than a local directory (i.e., change the drive information). Once the patches are available, an application or administrator may access the patches, review the patches and install the patches using a familiar interface (e.g., UI or API). Accordingly, embodiments of the invention are more fault-tolerant than requiring an administrator to query online patch sources, determine the patches to install, and retrieve the patches.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for maintaining patch information for a plurality of clients using a remote file system comprising:
obtaining component information from a report associated with each of the plurality of clients;
populating a patch file on the remote file system when a component found on the plurality of clients is not current based on component information; and
accessing the patch file on the remote file system to update the plurality of clients,
wherein the report and the patch file are stored in the remote file system.

2. The method of claim 1, wherein obtaining component information from the report and populating the patch file is performed by a backend data center.

3. The method of claim 2, wherein the remote file system is visible to the plurality of clients and the backend data center.

4. The method of claim 1, wherein the plurality of clients have an interface to the remote file system on a local directory of the plurality of clients.

5. The method of claim 4, wherein accessing the patch file on the remote file system to update the plurality of clients comprises:
obtaining a patch from the patch file using the interface to the remote file system; and
installing the patch on the plurality of clients.

6. The method of claim 1, further comprising:
authenticating the plurality of clients.

7. The method of claim 1, wherein the report comprises component information about each of a plurality of components on each client in the plurality of clients.

8. The method of claim 1, wherein the component information specifies a non-current component.

9. The method of claim 1, further comprising:
receiving a patch from a component vendor, wherein the patch file is populated with the patch from the component vendor.

10. A computer system for maintaining patch information for a plurality of clients using a remote file system comprising:
a remote file system for storing a report associated with each of the plurality of clients and a patch file;
a processor within the computer system for executing software instructions to perform:
obtaining component information from the report;
populating the patch file when a component found on the plurality of clients is not current based on component information; and
accessing the patch file on the remote file system to update the plurality of clients.

11. The computer system of claim 10, wherein the computer system is maintained at a backend data center.

12. The computer system of claim 11, wherein the remote file system is visible to the plurality of clients and the backend data center.

13. The computer system of claim 10, wherein the plurality of clients have an interface to the remote file system on a local directory of the plurality of clients.

14. The computer system of claim 13, wherein accessing the patch file on the remote file system to update the plurality of clients comprises:
obtaining a patch from the patch file using the interface to the remote file system; and
installing the patch on the plurality of clients.

15. The computer system of claim 10, wherein the processor further executes software instructions to perform:
authenticating the plurality of clients.

16. The computer system of claim 10, wherein the report comprises component information about each of a plurality of components on each client in the plurality of clients.

17. The computer system of claim 10, wherein the component information specifies a non-current component.

18. The computer system of claim 10, wherein the processor further executes software instructions to perform:
receiving a patch from a component vendor, wherein the patch file is populated with the patch from the component vendor.

19. A system for maintaining patch information for a plurality of clients using a remote file system comprising:
a digital software library for storing a patch; and
a business rules engine accessing the digital software library for:
obtaining component information from a report associated with each of the plurality of clients;
populating a patch file on the remote file system when a component found on the plurality of clients is not current based on component information; and
accessing the patch file on the remote file system to update the plurality of clients,
wherein the report and the patch file are stored in the remote file system.

20. The system of claim 19, wherein the patch is obtained from a component vendor.
